(19) United States
(12) Patent Application Publication
(10) Pub. No.: US 2025/0272932 A1
(43) Pub. Date: Aug. 28, 2025

(54) SYSTEMS AND METHODS FOR GENERATING OVERLAYS OF 3D MODELS IN 2D CONTENT ITEMS

(71) Applicant: Adeia Guides Inc., San Jose, CA (US)

(72) Inventors: Evgeny Kaminsky, Hallandale Beach, FL (US); Reda Harb, Tampa, FL (US); Charles Dasher, Lawrenceville, GA (US)

(21) Appl. No.: 18/590,385

(22) Filed: Feb. 28, 2024

(51) Int. Cl. G06T 19/20; G06F 3/04815; G06Q 30/0241; G06V 20/60

(52) U.S. Cl. CPC G06T 19/20; G06F 3/04815; G06Q 30/0276; G06V 20/60; G06T 2200/24; G06T 2219/2016

(57) ABSTRACT

Systems and methods are provided for generating and providing for display overlays of 3D models during display of two-dimensional (2D) content items at computing devices. At a user interface of a computing device, during display of a 2D content item, a user interaction associated with a first object displayed in the 2D content item is received. The first object is determined to be displayed in a threshold number of consecutive frames of the 2D content item. The first object and at least one attribute of the first object is identified. A 3D model of a second object based on the at least one attribute of the first object is retrieved. An overlay of the 3D model of the second object is provided for display during at the computing device during display of the 2D content item.

### BACKGROUND

This disclosure is directed to systems and methods for generating and providing for display overlays of 3D models of an object at a computing device during display of a 2D content item.

### SUMMARY

In recent years, video content consumption has substantially shifted, with audiences increasingly seeking more engaging, immersive, and interactive experiences. This change in consumer preference has led to the exploration of new technologies in video production, one of which is the creation of interactive three-dimensional (3D) overlays within video content. This technology involves superimposing 3D graphical elements over standard two-dimensional (2D) content items, thereby enhancing the depth, realism, and interactivity of the viewing experience. However, the integration of 3D overlays into 2D video presents several challenges. First, there is the technical hurdle of seamlessly blending 3D graphics with 2D video in real time without compromising the content item's quality or playback performance. This requires sophisticated rendering techniques and potent processing capabilities, especially when overlays must respond dynamically to user interactions. Additionally, there's the challenge of ensuring that these 3D elements are intuitive and add value to the user's experience rather than being distracting or overwhelming. The design and implementation of these overlays must be carefully considered to enhance, rather than detract from, the storytelling or informational goals of the video content.

Another significant concern is the accessibility and compatibility of these advanced features across various platforms and devices. With a wide range of devices being used to consume video content, from smartphones to high-end virtual reality (VR) headsets, ensuring consistent and optimal performance of 3D overlays across this spectrum is a complex task. Furthermore, for creators and businesses, there's the task of measuring the effectiveness of these 3D overlays in terms of user engagement and return on investment. This involves the technical implementation and understanding of user behavior and preferences.

In some approaches, content providers have attempted to increase user engagement via interactive elements. Such interactive elements include “choose your own adventure” experiences, where users watching a content item are prompted to select which of a plurality of scenes they would like to be inserted into their viewing experience of the content item. While such features provide opportunity for user interaction, these interactive elements are only available for select content items and select content providers. An interactive feature that can be implemented universally across any platform is still left to be desired. In another approach, objects or people within a content item may be highlighted and additional information about the objects or people is provided to users. While highlighting objects provides one way for users to interact with a content item, users can only receive additional information for objects or people that are pre-selected by the content provider regardless of which objects or people the user is interested in.

To address these problems, in some embodiments, a 3D system (3DS) receives at a user interface of a computing device, during display of a two-dimensional (2D) content item, a user interaction associated with a first object displayed in the 2D content item. For example, during display of a 2D content item (e.g., a movie) at a computing device (e.g., a television), the 3DS detects movement of a remote pointer at a region of the screen of the television that is currently displaying a car (i.e., a user interaction associated with a first object displayed in the 2D content item). In some embodiments, the 3DS determines that the first object is displayed in a threshold number of consecutive frames of the 2D content item. The 3DS may determine how many frames the first object will be in through metadata of the 2D content item. For example, the 3DS determines that the car in the movie (i.e., the first object) is displayed in, e.g., ten consecutive frames of the movie. Such aspects confirm that the first object is in enough frames of the 2D content item to be analyzed by the 3DS. In some embodiments, the 3DS identifies the first object and at least one attribute of the first object. For example, the 3DS identifies that the car in the movie (i.e., the first object) is a Dodge Challenger SRT Demon in the color TorRed (i.e., at least one attribute of the first object).

In some embodiments, the 3DS retrieves a three-dimensional (3D) model of a second object based on at least one attribute of the first object. In some implementations, the second object is the first object. For example, the 3DS retrieves a 3D model of a Dodge Challenger SRT Demon in the color TorRed (i.e., a second object that is the first object). In some implementations, the second object is unique from the first object. For example, the 3DS retrieves a 3D model of Ford Mustang Shelby GT500 in the color Race Red (i.e., the second object that is unique from the first object). Whether the second object is the first object or is unique from the first object, the 3DS retrieves the 3D model of the second object based on the attribute of a red sports car (i.e., at least one attribute of the first object). In some embodiments, the 3DS provides for display an overlay of the 3D model of the second object at the computing device during display of the 2D content item. For example, the 3DS provides for display an overlay of the 3D model of the Ford Mustang Shelby GT500 (i.e., the second object) at the television during display of the movie (i.e., at the computing device during display of the 2D content item). Such aspects allow for existing content-providing services to integrate 3D overlays into their content items, so the 3DS can provide an immersive user experience to the user or users watching the 2D content item, therefore maintaining the interest of the user or users.

In response to the providing for display the overlay of the 3D model of the second object at the computing device, the 3DS, in some embodiments, receives a second user interaction at the overlay of the 3D model of the second object. For example, the 3DS detects movement of a remote pointer at the overlay of the 3D model of the Ford Mustang Shelby GT500. In some implementations, in response to the receiving the second user interaction, the 3DS modifies at least one of an orientation or a size of the overlay of the 3D model. For example, the 3DS zooms in on a region of the overlay of the 3D model of the Ford Mustang Shelby GT500. In another example, the 3DS rotates the overlay of the 3D model of the Ford Mustang Shelby GT500 such that the user may see the 3D model from a new perspective. Such aspects allow for further user interaction and immersion with the 3D representation of the 2D content item.

In some embodiments, in response to the receiving the second user interaction, the 3DS provides for display data of the second object at the user interface of the computing device. For example, the 3DS provides for display in, e.g., a pop-up window, information about the Ford Mustang Shelby GT500 (e.g., car specifications such as dimensions, number of doors, etc.). Such aspects provide for increased user interaction with the 3D model, and, by proxy, the 2D content item. In some implementations, the data of the second object is advertising data. For example, the 3DS provides for display in, e.g., a pop-up window, advertisements for Ford Mustangs for purchase near the geographic location of the computing device and/or Ford dealerships near the geographic location of the computing device. Such aspects allow advertisers to utilize the overlays of 3D models to advertise their products and/or services to users that have expressed direct interest in the object. Such aspects also allow advertisers to present more features of their products and/or services than traditional 2D advertisements.

The 3DS retrieves, in some implementations, a 3D model of a third object based on at least one attribute of the second object and provides an overlay of the 3D model of the third object at the computing device during display of the 2D content item. For example, the 3DS provides for display an overlay of a 3D model of a gas nozzle (i.e., a third object) because a Ford Mustang has a gas tank that needs to be filled (i.e., at least one attribute of the second object). In some embodiments, the 3DS generates for display a prompt at the user interface of the computing device. For example, the 3DS generates for display a prompt at the user interface of the television, suggesting to the user to pump gas into the 3D model of the Ford Mustang using the 3D model of the gas nozzle. The 3DS receives, in some cases, a second user interaction at the overlay of the 3D model of the second object via the 3D model of the third object, wherein the second user interaction is responsive to the prompt. For example, the 3DS receives an indication that the user that is viewing the 2D content item has performed the motions associated with pumping gas into the 3D model of the Ford Mustang using the 3D model of the gas nozzle. In response to the receiving the second user interaction, in some embodiments, the 3DS terminates display of the prompt at the user interface of the computing device and displays a portion of the 2D content item at the computing device based on the second user interaction. For example, the 3DS stops displaying the prompt suggesting to the user to pump gas, and displays a portion of the movie where the car, e.g., the Dodge Challenger, speeds off into the distance (i.e., 2D content item at the computing device based on the second user interaction). Such aspects provide yet another opportunity for users to interact with the 2D content item.

In some embodiments, wherein the computing device is an extended reality (XR) device, the 3DS analyzes at least one frame of the consecutive frames of the 2D content item. For example, the 3DS determines, based on analyzing at least one frame of the consecutive frames of a movie, that the setting of the at least one frame of the movie is a volcano with lava and fire. In some cases, the 3DS analyzes an environment proximate to the XR device and outpaints the at least one frame of the 2D content item using generative artificial intelligence (AI). In some embodiments, the 3DS projects the outpainted frame of the 2D content item at the environment around the XR device and receives a second user interaction at the outpainted frame displayed at the environment, wherein at least one object of the outpainted frame is interactive. In some embodiments, the 3DS performs depth analysis of the environment and of the outpainted frame to texturize the environment. For example, the 3DS analyzes the environment around the television and projects an outpainted frame of a volcanic scene using, e.g., DALL-E. The 3DS then detects a user interaction with a volcanic rock, e.g., the user “picks up” the volcanic rock using XR. Such aspects provide an immersive experience for users viewing the 2D content item and provide further interaction opportunities.

In response to identifying coordinates of the first object in at least one frame of the consecutive frames of the 2D content item, the 3DS provides, in some implementations, for display the overlay of the 3D model at coordinates proximate to the identified coordinates of the first object. For example, in response to identifying that the Dodge Challenger (i.e., first object) is in the bottom-left corner of the display of the 2D content item for several frames, the 3DS displays the overlay of the 3D model of the Ford Mustang (i.e., the second object) near the bottom-left corner of the display of the 2D content item.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an illustrative example of a three-dimensional system for providing for display an overlay of a 3D model of an object at a computing device during display of a 2D content item, in accordance with some embodiments of this disclosure.

FIG. 2 shows an illustrative example of a three-dimensional system for displaying a portion of a 2D content item based on a user interaction with an overlay of a 3D model via a 3D model of another object, in accordance with some embodiments of this disclosure.

FIG. 3 shows an illustrative example of a three-dimensional system for providing for display an overlay of a 3D model of an object and data of the object at an extended reality device during display of a 2D content item, in accordance with some embodiments of this disclosure.

FIG. 4 shows an illustrative example of user interfaces of a three-dimensional system for extended reality (XR) devices providing for display interactive 3D models, in accordance with some embodiments of this disclosure.

FIG. 5 shows an illustrative example of a three-dimensional system for generating an outpainting of at least one frame of a 2D content item and display the outpainted frame and a 3D scene based on the outpainted frame at an environment, in accordance with some embodiments of this disclosure.

FIG. 6 depicts illustrative devices, systems, servers, and related hardware for generating and providing overlays of 3D models of objects at computing devices during display of 2D content items, in accordance with some embodiments of this disclosure.

FIG. 7 depicts illustrative devices, systems, servers, and related hardware for generating and providing overlays of 3D models of objects at computing devices during display of 2D content items, in accordance with some embodiments of this disclosure.

FIG. 8 is a flowchart of an illustrative process for providing for display an overlay of a 3D model of an object at a computing device during display of a 2D content item, in accordance with some embodiments of this disclosure.

FIG. 9 is a flowchart of an illustrative process for a three-dimensional system for providing for display an overlay of a 3D model of an object at a computing device during display of a 2D content item for client devices with powerful processing capabilities, in accordance with some embodiments of this disclosure.

FIG. 10 is a flowchart of an illustrative process for a three-dimensional system, characterized by reliable, ultra-low latency network connections, for providing for display an overlay of a 3D model of an object at a computing device during display of a 2D content item, in accordance with some embodiments of this disclosure.

FIG. 11 is a flowchart of an illustrative process for a three-dimensional system for providing for display an overlay of a 3D model of an object at a computing device during display of a 2D content item for client devices that can render 3D models and are simultaneously connected to a high-quality network for interactive streaming from a server, in accordance with some embodiments of this disclosure.

FIG. 12 is a flowchart of an illustrative process for a three-dimensional system for transforming a standard 2D content item into an immersive 3D environment, in accordance with some embodiments of this disclosure.

### DETAILED DESCRIPTION

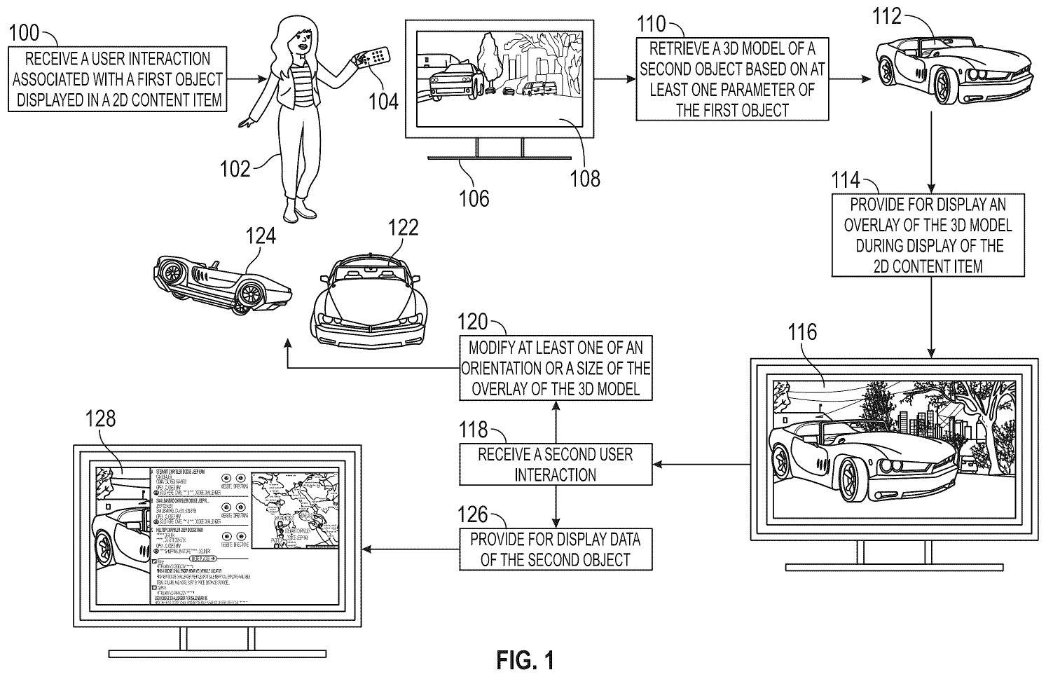

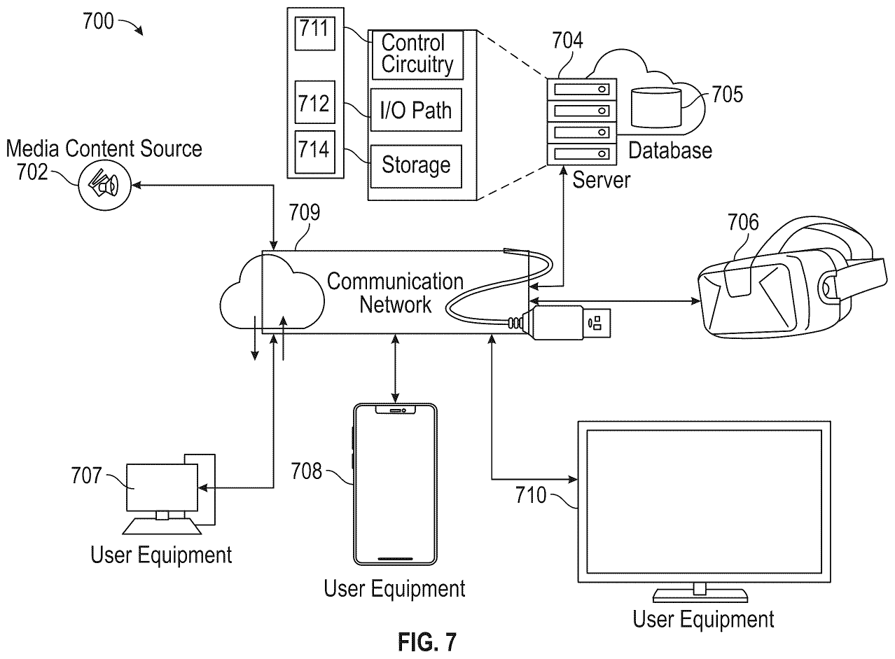

FIG. 1 shows an illustrative example of a three-dimensional (3D) system (3DS) for generating and providing for display an overlay of a 3D model of an object at a computing device during display of a 2D content item, in accordance with some embodiments of this disclosure. In some embodiments, a 3D application runs on a 3DS, e.g., on one or more devices 704, 706, 707, 708, 710 as shown and described below in connection with FIG. 7. In some implementations, the 3D application runs on a server, a cloud service, a user equipment device (e.g., a laptop, smartphone, tablet, television, XR/VR/AR/MR headset), any other suitable device, or any combination thereof. The 3D application may be hosted on a standalone server, in a cloud service, directly on a user equipment device, on a desktop or workstation, any other suitable host or any combination thereof. In some embodiments, the 3D application functions though a collaborative setup involving a server or cloud service and a user equipment device. The device running the 3DS may provide for display content items via content item providers also known as a media content provider. Content item providers may be subscription-based streaming services (e.g., over-the-top or OTT services), broadcast services, user-generated content websites, extended reality (XR) content providers, video game providers, any other suitable content item provider, or any combination thereof. For example, device 106 displays a movie from a streaming service at user interface 108. In some embodiments, the 3DS is a native service of the content item provider, an API, or a plug-in application.

In some embodiments, at step 100, the 3D application receives a user interaction associated with a first object displayed in a 2D content item. For example, a television displaying a movie via a user interface, e.g., device 106 displaying a 2D content item via user interface 108, receives infrared light pulses or other suitable wireless transmissions from a remote control, e.g., remote 104 operated by user 102. User 102 aims remote 104 toward the area of user interface 108 that displays a first object within the 2D content item, e.g., a car. The device on which user interface 108 is presented (e.g., a television) may be configured to track the position and orientation of remote 104 and determine the area of user interface 108 at which the user aims remote 104. In some implementations, the 3D application receives a user interaction associated with a first object displayed in a 2D content item via an eye gaze. For example, the 3D application, when implemented at an XR device, receives an eye gaze towards an object displayed in a movie. In some embodiments, the 3D application receives a user interaction associated with a first object displayed in a 2D content item via a camera of the device recognizing a gesture from a user (e.g., a user pointing to a section of a screen of the device displaying an object). The 3D application, in some embodiments, receives a user interaction associated with a first object displayed in a 2D content item via the voice of a user. For example, the 3D application may receive an indication that a user is talking about a particular object displayed in a movie and in response, the 3D application may determine the location of the object within the 2D content item. In some embodiments, the 3D application determines that the first object is displayed in a threshold number of consecutive frames of the 2D content item. For example, the 3D application determines that the car has been displayed in more than, e.g., 100 consecutive frames of the movie displayed at user interface 108. The 3D application may determine that the first object is displayed in at least the threshold number of consecutive frames by maintaining a buffer. For example, the 3D application determines that one of the objects present in the 2D content item, at the time of the user interaction, is a car. The 3D application may then check, via the buffer, if the previous frames included the car. The 3D application may determine that the first object is displayed in at least the threshold number of consecutive frames via metadata of the 2D content item.

In response to determining that the first object is displayed in at least the threshold number of consecutive frames of the 2D content item, the 3D application identifies the first object and at least one attribute of the first object. The 3D application may identify the first object and the at least one attribute in various ways, such as localization of the object's image within frames of the 2D content item, video object tracking, artificial intelligence (AI) image recognition, any suitable video object detection technique or combination thereof. For example, the 3D application uses AI image recognition to identify that the first object in the 2D content item, which was interacted with via remote 104, is a Dodge Challenger. The 3D application also identifies at least one attribute of the Dodge Challenger, e.g., it is a red SRT Demon (released in 2018). At step 110, in some implementations, the 3D application retrieves a 3D model of a second object, e.g., 3D model 112, based on the at least one attribute of the first object. The 3D model may be retrieved from the content provider providing the 2D content item that is displayed at user interface 108 of device 106, a 3D model datastore accessible to the 3D application, any suitable 3D model provider, or any combination thereof. For example, the 3D application retrieves 3D model 112 from the streaming service providing the movie that is displayed by device 106. In some embodiments, the 3D application generates, rather than retrieves, a 3D model of a second object based on the at least one attribute of the first object. The 3D application may use AI to generate the 3D model.

In some embodiments, the second object is the first object. For example, the 3D application retrieves a 3D model of a Dodge Challenger (e.g., the first object displayed in the movie and the second object based on the at least one attribute of the first object). In some embodiments, the second object is different from the first object. For example, rather than retrieving a 3D model of a Dodge Challenger (e.g., the first object), the 3D application may retrieve a 3D model of, e.g., a red Ford Mustang. The 3D application may retrieve the 3D model of the Ford Mustang based on the attribute of the first object, e.g., the Dodge Challenger, being a red sports car. In some embodiments, the data of the second object is advertising data. For example, Ford may have an advertising deal with the streaming service that is streaming the movie to device 106. The 3D application may determine that a Ford Mustang is similar to a Dodge Challenger based upon shared attributes (e.g., being a sports car). Thus, in response to receiving a user interaction, via remote 104, with the Dodge Challenger in the movie at user interface 108, the 3D application retrieves a 3D model of a red Ford Mustang instead of a 3D model of the Dodge Challenger. The 3D application may determine the second object based on personal preferences learned from past user interactions. For example, the 3D application learns from past user interactions that the user often interactions with Ford-related content, thus a 3D model of a Ford Mustang is retrieved. The 3D application may determine that the user is the target audience for an advertiser. In some embodiments, the second object is a generic version of the first object. For example, in response to receiving a user interaction of the Dodge Challenger in the movie, the 3D application retrieves a 3D model of a generic red sports car.

At step 114, in some implementations, the 3D application provides for display an overlay of the 3D model, e.g., 3D model 112, during display of the 2D content item. For example, the 3D application provides for display 3D model 112 at user interface 116 of device 106 during display of the movie. The 3D model may be stored as an OBJ file, FBX file, GLTF file, GLB file, USD file, CAD file, any other suitable 3D data file format, or any combination thereof. The 3D application renders the 3D model for display and overlays the rendered 3D model over the 2D content. In some embodiments, in response to identifying coordinates of the first object in at least one frame of the consecutive frames of the 2D content item, the 3D application provides for display the overlay of the 3D model at coordinates proximate to the identified coordinates of the first object. For example, the 3D application identifies that the first object, e.g., the Dodge Challenger, in the movie is displayed approximately in the left horizontal segment and the center vertical segment of user interface 108. In response, the 3D application provides for display an overlay of 3D model 112 of the second object, e.g., the Ford Mustang, in the left horizontal segment and the center vertical segment of user interface 116, covering the display of the first object in the movie. In some embodiments, the 3D application provides for display the 3D model of the second object at a portion of user interface 108 that is not currently displaying the first object. The 3D application may provide for display the 3D model of the second object in a free space of user interface 108.

At step 118, in some embodiments, the 3D application receives a second user interaction at the overlay of the 3D model of the second object. For example, the 3D application may receive infrared light pulses from remote 104 directed toward the segment of user interface 116 that is currently displaying the overlay of 3D model 112 of the second object. In some implementations, in response to receiving the second user interaction at step 118, the 3D application modifies at least one of an orientation or a size of the overlay of the 3D model. For example, the 3D application displays 3D models 122 and 124 of the second object represented by 3D model 112 in modified orientations and sizes, e.g., 3D models 122 and 124 are enlarged and rotated. At step 126, in some embodiments, in response to receiving the second user interaction, the 3D application provides for display data of the second object at the user interface of the computing device, e.g., user interface 128.

The 3D application may display the data of the second object as an overlay over the display of the 2D content item and 3D model of the second object. The 3D application may display the data of the second object in a pop-up window overlaid over the display of the 2D content item and 3D model of the second object. In some embodiments, the data of the second object comprises information about the second object, e.g., the data of the Ford Mustang may comprise car specifications such as dimensions, number of doors, etc. In some implementations, the data of the second object is advertising data. For example, the 3D application provides for display in, e.g., a pop-up window at user interface 128, advertisements for Ford Mustangs for purchase near the geographic location of the device 106 and/or Ford dealerships near the geographic location of the device 106. In some embodiments, the 3D application, in response to receiving the user interaction with the 3D model of the second object, provides for display data of the first object. For example, in response to receiving a user interaction with 3D model 112, wherein 3D model 112 is a generic red sports car based on the first object (e.g., Dodge Challenger), the 3D application provides for display at least one of advertising data of the first object or information about the first object such as car specifications.

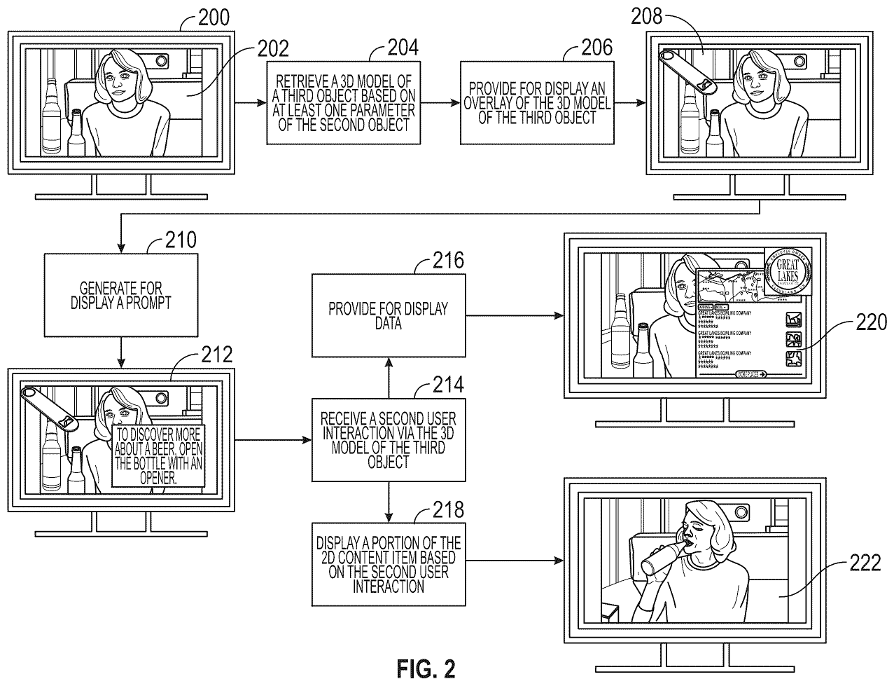

FIG. 2 shows an illustrative example of a 3D system (e.g., the 3DS as described above in connection with FIG. 1) for displaying a portion of a 2D content item based on a user interaction with an overlay of a 3D model via a 3D model of another object, in accordance with some embodiments of this disclosure. In some embodiments, a 3D application runs on the 3DS, as described above in connection with FIG. 1.

In some embodiments, device 200, e.g., a television, displays a movie from a streaming service at user interface 202. The 3D application determines that the 2D content item displayed at user interface 202 by device 200 displays a first object, e.g., a Great Lakes beer bottle, for a threshold number of consecutive frames, as described above in connection with FIG. 1. The 3D application, as described above in connection with FIG. 1, provides for display an overlay of a retrieved 3D model of a second object, e.g., a generic beer bottle, in response to receiving a user interaction directed toward a portion of user interface 202 displaying the Great Lakes beer bottle. At step 204, in some embodiments, the 3D application retrieves a 3D model of a third object based on at least one attribute of the second object. For example, the 3D application retrieves a 3D model of a bottle opener, e.g., a third object, based on an attribute of the generic beer bottle, e.g., the second object, being that the bottle comprises a pry-off cap. In some embodiments, at step 206, the 3D application provides for display an overlay of the 3D model of the third object. For example, the 3D application provides for display an overlay of the 3D model of a bottle opener during display of the movie displayed by device 200 at user interface 208.

At step 210, in some embodiments, the 3D application generates for display a prompt. For example, the 3D application generates for display, as, e.g., an overlay, a prompt that says “To discover more about a beer, open the bottle with an opener” at user interface 212. The prompt may indicate to a user of device 200 to interact with the 3D models of the second object and the third object. The prompt may indicate to a user of device 200 that interacting with the 3D model of the second object via the 3D model of the third object results in display of at least one of additional information about the second object or a portion of the 2D content item based on the interaction. At step 214, in some implementations, the 3D application receives a second user interaction at the overlay of the 3D model of the second object via the 3D model of the third object in response to the prompt. For example, the 3D application may receive a second user interaction of the 3D model of the generic beer bottle via the 3D model of the bottle opener. A user of device 200 may aim a remote control, e.g., remote 104 as described above in connection with FIG. 1, toward the area of user interface 212 that displays the 3D model of the bottle opener. Device 200 may be configured to track the position and orientation of remote 104 and determine the area of user interface 212 at which the user aims remote 104. In response to device 200 determining that remote 104 has moved in a motion similar to that of opening a bottle (e.g., the action prompted at user interface 212), the 3D application may determine that a second user interaction responsive to the prompt has been received.

In some embodiments, in response to receiving the second user interaction, the 3D application terminates display of the prompt at the user interface of the computing device. At step 216, in some embodiments, the 3D application provides for display advertising data of the first object or the second object. For example, the 3D application provides for display data for Great Lakes beer (e.g., the first object) at user interface 220 of device 200 during display of the movie. The data may include stores in geographic locations near device 200 where Great Lakes beer is available for purchase. The data may include facts about Great Lakes beer. In some implementations, particular portions of the 2D content item are associated with a second user interaction (e.g., an action) that results in the 3D application overriding default portions of the 2D content item. At step 218, in some implementations, the 3D application displays a portion of the 2D content item based on the second user interaction. The portion of the 2D content item based on the second user interaction may override default portions of the 2D content that are displayed when the 3D application does not receive a second user interaction. The 3D application may terminate display of the 3D models of the second object and the third object. For example, based on receiving the second user interaction (e.g., an indication of an action imitating opening a bottle), the 3D application, via the content item provider, provides for display a scene of the movie in which an actor drinks from a bottle (e.g., the first object) at user interface 222 of device 200 and terminates display of the 3D models of the generic beer bottle and the bottle opener. The alternative scene may be associated with particular segments of the 2D content item (e.g., segments 24-28). The 3D application receiving the second user interaction with the bottle triggers the 3D application to display the alternative scene in place of, e.g., segments 24-28. The alternative scene may also comprise five segments to replace segments 24-28. In some embodiments, the 3D application does not display said portion of the 2D content item without receiving the second user interaction. For example, if the 3D application does not receive an indication of an action imitating opening a bottle, the scene of the movie in which an actor drinks from a bottle will not be displayed and a different scene in which the actor does not drink from the bottle will be displayed instead. Both the portion of the 2D content item based on the second user interaction and the default portion of the 2D content item, in some embodiments, share content data (e.g., audio data).

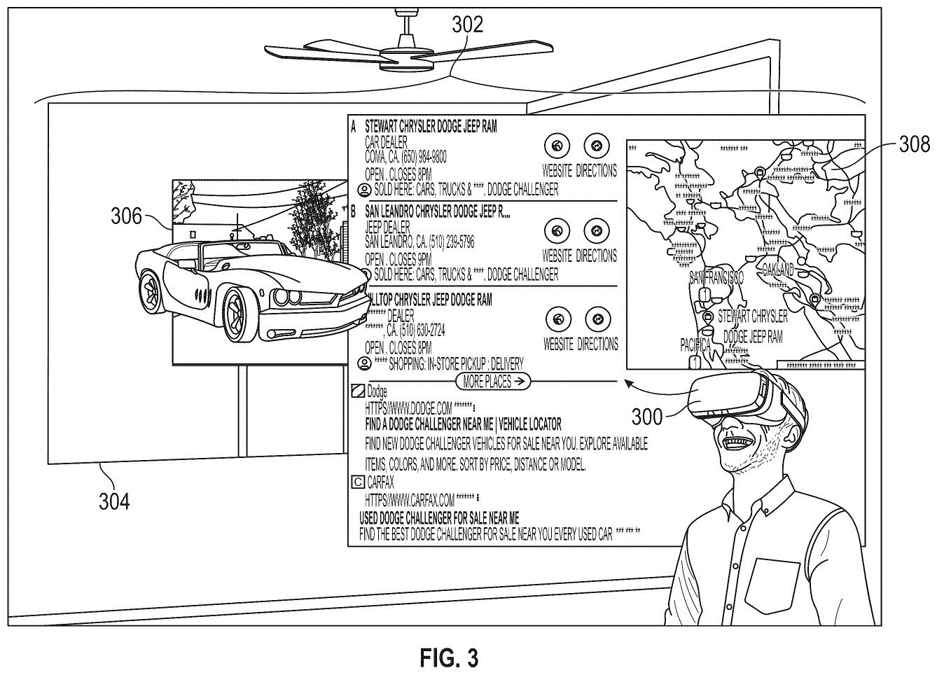

FIG. 3 shows an illustrative example of a three-dimensional system (e.g., the 3DS as described above in connection with FIG. 1) for providing for display an overlay of a 3D model of an object and data of the object at an extended reality device during display of a 2D content item, in accordance with some embodiments of this disclosure. In some embodiments, a 3D application runs on the 3DS, as described above in connection with FIG. 1. In some embodiments, the 3D application runs on an XR device, e.g., a VR headset such as device 300. Device 300, in some implementations, provides for display a 2D content item (e.g., movie 304), via a streaming service, at user interface 302. The 3D application may receive a user interaction associated with a first object, at the user interface of the XR device, displayed in the 2D content item. The XR device may receive user interactions via one or more of hand controllers associated with the XR device, detected eye movements, detected eye gaze for at least a threshold period of time (e.g., 1 second), the hand(s) of a user associated with the XR device, any other suitable XR user interaction medium, or any combination thereof. The XR device may be configured to track the position and orientation of the XR user interaction medium and determine the area of user interface 302 toward which the user indicates interest. For example, the 3D application, via device 300, may receive an indication that the user currently wearing device 300 held out their hand and pointed their index finger toward a portion of user interface 302 currently displaying a first object (e.g., a Dodge Challenger).

In some embodiments, the 3D application determines that the first object is displayed in at least a threshold number of consecutive frames of the 2D content item. For example, the 3D application determines that the car is displayed in more than, e.g., 100 consecutive frames of the movie displayed at user interface 302. In response to determining that the first object is displayed in at least the threshold number of consecutive frames of the 2D content item, the 3D application identifies the first object and at least one attribute of the first object, as described above in connection with FIG. 1. For example, the 3D application identifies the first object as a Dodge Challenger and that it is red. The 3D application, as described above in connection with FIG. 1, provides for display an overlay of a retrieved 3D model 306 of a second object in response to receiving a user interaction directed toward a portion of user interface 302 displaying the Dodge Challenger. For example, the 3D application may retrieve 3D model 306 of a Dodge Challenger based on the first object being identified as a Dodge Challenger.

In some embodiments, the 3D application provides for display an overlay of the 3D model of the second object over the display of the 2D content item. For example, the 3D application provides for display an overlay of 3D model 306 at user interface 302 during display of movie 304. The 3D application may, in some implementations, provide for display an interactive overlay of data of the first object or the second object. For example, the 3D application provides for display advertising data 308 of the Dodge Challenger (e.g., the first object and the second object) at user interface 302 of device 300. A user wearing device 300 may interact with advertising data 308 via any suitable XR user interaction medium.

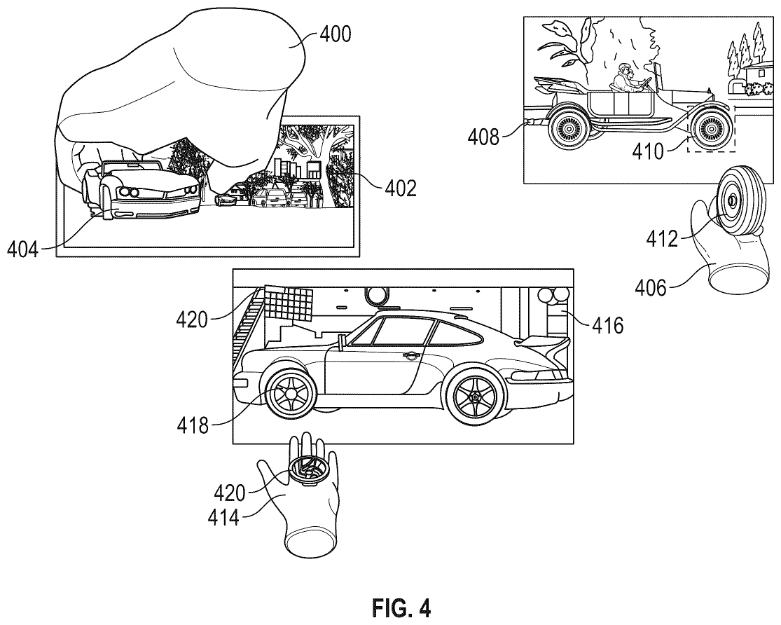

FIG. 4 shows an illustrative example of user interfaces of a 3D system (e.g., the 3DS as described above in connection with FIG. 1) for XR devices providing for display interactive 3D models, in accordance with some embodiments of this disclosure. In some embodiments, a 3D application runs on the 3DS, as described above in connection with FIG. 1. In some implementations, the 3D application provides for display a user-interactive overlay of a 3D model of a second object, based on at least one attribute of a first object within a 2D content item displayed at a user interface of an XR device. For example, as described above in connection with FIG. 1, the 3D application receives a user interaction with a first object displayed in a movie at a user interface, e.g., user interface 402. The 3D application may determine that the first object is displayed in a threshold number of consecutive frames, and then may identify the first object as a Dodge Challenger. The 3D application then may retrieve and provide for display 3D model 404 of a second object, e.g., a generic red car, at user interface 402.

In some embodiments, the 3D application receives, via the XR device displaying the 2D content item, a second user interaction with 3D model 404. For example, the user using the XR device, e.g., user 400, reaches their hand out toward the region of user interface 402 where 3D model 404 is currently displayed. The 3D application, in some embodiments, receives an indication of user 400 reaching toward 3D model 404 and, in response, modifies the display of 3D model 404 in accordance with the movement of the hand of user 400. For example, the 3D application may enlarge, shrink, rotate, or transpose 3D model 404 depending on the hand movement of user 400.

User interface 408 displays another 2D content item that is currently displaying a first object, e.g., a black car. The black car may comprise many parts, such as a steering wheel, tires (e.g., wheel 410), tire rims, etc. As described above in connection with FIG. 1, the 3D application retrieves and provides for display a 3D model of the black car at user interface 408. Once the 3D model is retrieved and displayed as an overlay at user interface 408, the 3D application may receive, via the XR device displaying user interface 408, a user interaction from user 406. The user interaction from user 406 is directed toward the portion of user interface 408 displaying wheel 410. The 3D application, in some embodiments, determines that the user interaction from user 406 is directed toward an auxiliary object, e.g., wheel 410. In response, the 3D application extracts the portion of the 3D model of the black car associated with wheel 410, e.g., auxiliary 3D model 412. In some implementations, the 3D application enables user 406 to interact with auxiliary 3D model 412 independently of the entire 3D model of the black car.

User interface 416 displays another 2D content item that is currently displaying a first object, e.g., a black car. The black car may comprise many parts, such as a steering wheel, tires, tire rims, etc. As described above in connection with FIG. 1, the 3D application retrieves and provides for display a 3D model of a second object, e.g., a 3D model of the black car, at user interface 416. In some implementations, the 3D application retrieves and provides for display auxiliary 3D models, e.g., flag 420 and tire rim 418, at user interface 416. Flag 420 and tire rim 418 may be retrieved based on advertising data associated with the first object or the second object. Once the 3D models are retrieved and displayed as an overlay at user interface 416, the 3D application may receive, via the XR device displaying user interface 416, a user interaction from user 414. The user currently using the XR device, e.g., user 414, reaches their hand toward the area of user interface 416 that is currently displaying the overlay of the auxiliary 3D model of tire rim 418. In response to receiving the user interaction, the 3D application may enable user 414 to interact with the auxiliary 3D model of tire rim 418 independently of if a 3D model of the entire black car is provided. In addition to modifying the orientation and/or size of the 3D model of tire rim 418, the 3D application may also provide an overlay or pop-up window of advertising data associated with tire rim 418 at user interface 416.

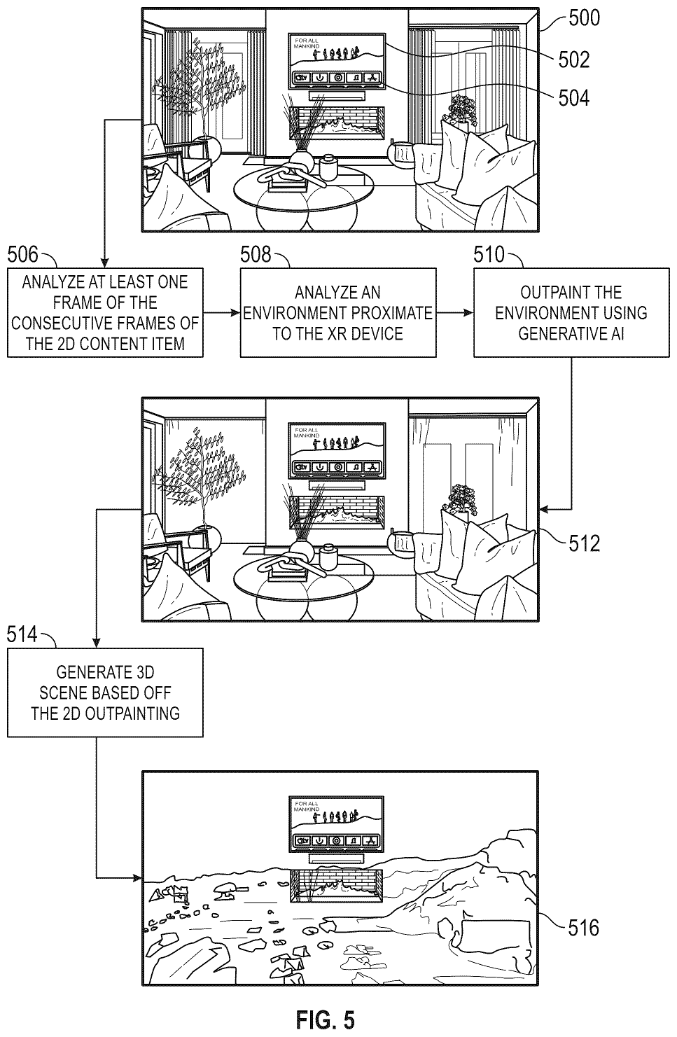

FIG. 5 shows an illustrative example of a 3D system (e.g., the 3DS as described above in connection with FIG. 1) for generating an outpainting of at least one frame of a 2D content item and display the outpainted frame and a 3D scene based on the outpainted frame at an environment, in accordance with some embodiments of this disclosure. In some embodiments, a 3D application runs on the 3DS, as described above in connection with FIG. 1. In some implementations, display device 502, e.g., a television, displays a movie from a streaming service via user interface 504. A user may view environment 500, e.g., comprising display device 502, user interface 504, and the area surrounding display device 500, via an XR device. For example, environment 500 depicts a living room including display device 502 (e.g., a television); a fireplace; a coffee table; a couch; etc., through the lens of an XR headset. At step 506, in some embodiments, the 3D application analyzes at least one frame of the consecutive frames of the 2D content item (as described above in connection with FIG. 1) displayed at user interface 504 of display device 502. The 3D application may analyze the at least one frame of the consecutive frames of the 2D content item using a camera integrated into the XR device, which provides a live feed of both the video content of the 2D content item and the immediate environment, e.g., environment 500. The 3D application may analyze the at least one frame of the consecutive frames of the 2D content item based on attributes such as foreground and background objects displayed, people displayed, the relative speed of objects, any other suitable attribute, or any combination thereof. At step 508, in some implementations, the 3D application analyzes an environment proximate to the XR device, e.g., via the live feed captured by the camera integrated into the XR device.

In some embodiments, at step 510, the 3D application outpaints the at least one frame using generative AI. Generative AI, employing convolutional neural networks, may perform the outpainting (e.g., a method where the generative AI extrapolates and extends the 2D content item scene beyond the physical boundaries of user interface 504 of display device 502). Outpainting may create a continuous visual canvas that incorporates elements of environment 500, thus blending the digital content with the real-world space. In some implementations, the outpainted frame is displayed at the user interface of the XR device, e.g., environment 512. For example, the 3D application may display environment 512 if a user of the XR device requests to view the area behind and beyond the display screen of display device 502 as a persistence of vision or in a more detailed way when the 2D content item is paused or when static content is shown on display device 502.

In some embodiments, the resulting outpainting may be used for 3D scene creation. At step 514, in some implementations, the 3D application generates a 3D scene based on the 2D outpainting. The 3D application may apply simultaneous localization and mapping (SLAM) techniques to map and understand environment 512. The 3D application may employ feature-based SLAM, where the algorithm identifies and tracks distinct features (like edges or corners) within both the 2D content item and the room. As the 2D content item plays and these features move or change, the SLAM system continuously updates its understanding of the XR camera's position relative to these features, effectively mapping the spatial relationship of the 2D content item within the 3D coordinates of the room. In some embodiments, depth estimation algorithms such as multi-scale deep aggregated stereo matching (a monocular depth estimation algorithm) or DenseDepth (a depth estimation algorithm that utilizes deep learning, specifically designed to infer the depth information from a single image) analyze the video frames of the 2D content item to generate depth maps. These depth maps depict the perceived distance of objects from the viewpoint of the XR camera, adding a layer of 3D depth to the 3D scene. This depth information, combined with the spatial mapping from the SLAM process, results in a comprehensive 3D reconstruction of the video scene of the 2D content item that now includes elements of the physical space around the XR device and display device 502.

In some embodiments, the 3D application displays, at the user interface of the XR device, a 3D projection of the video scene of the 2D content item that is adapted to fit the room's layout (e.g., 3D-projected environment 516), with adjustments for factors like lighting, furniture placement, and room dimensions. Elements from the 2D content item may appear, to a user of the XR device, to step out of the display screen of display device 502 and into the physical environment of the user. The 3D application may allow a user associated with the XR device to interact with this blended reality using various control mechanisms of the XR device. For example, users may move around the room to view different aspects of the 3D scene from multiple perspectives, and to interact with the projected video elements, the physical objects in the room, and the 3D objects. The 3D application may allow the user of the XR device to influence the 2D content item narrative through their interactions with the 3D objects, as described above in connection with FIG. 2.

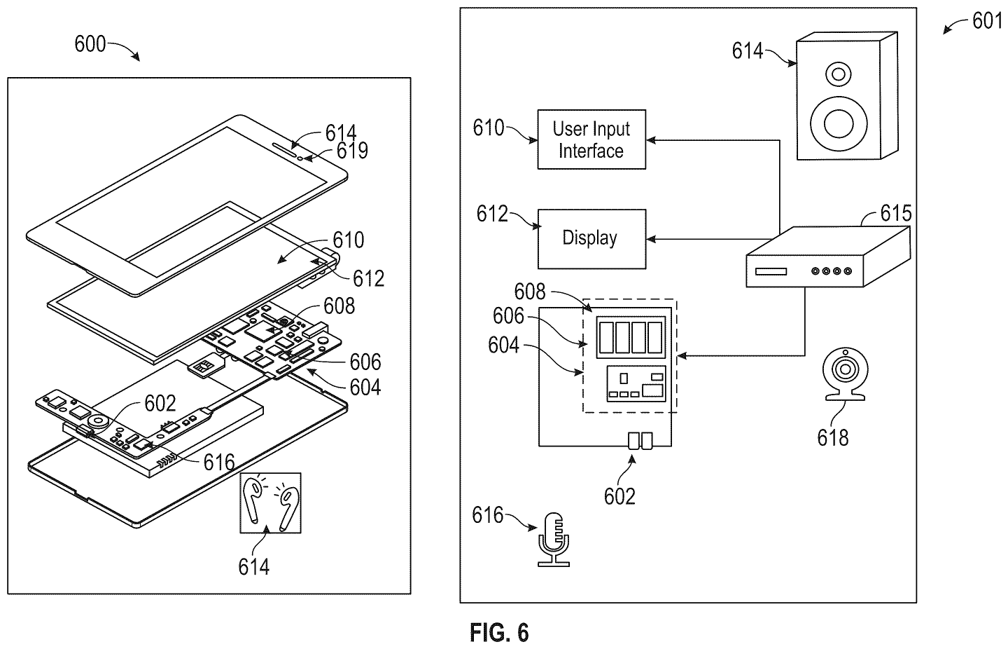

FIGS. 6-7 describe illustrative devices, systems, servers, and related hardware for generating and providing overlays of 3D models of objects at computing devices during display of 2D content items in accordance with some embodiments of the present disclosure. FIG. 6 shows generalized embodiments of illustrative user equipment 600 and 601, which may correspond to, e.g., computing device 102 of FIG. 1, computing device 200 of FIG. 2, or computing device 300 of FIG. 3. For example, user equipment 600 may be a smartphone device, a tablet, a near-eye display device, an XR device, or any other suitable device capable of participating in a XR environment, e.g., locally or over a communication network. In another example, user equipment 601 may be a user television equipment system or device. User equipment 601 may include set-top box 615. Set-top box 615 may be communicatively connected to microphone 616, audio output equipment 614 (e.g., speaker or headphones), and display 612. In some embodiments, microphone 616 may receive audio corresponding to a voice of a user and/or ambient audio data. In some embodiments, display 612 may be a television display or a computer display. In some embodiments, set-top box 615 may be communicatively connected to user input interface 610. In some embodiments, user input interface 610 may be a remote-control device. Set-top box 615 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment are discussed below in connection with FIG. 7. In some embodiments, user equipment 600 may comprise any suitable number of sensors (e.g., gyroscope or gyrometer, or accelerometer, etc.), and/or a GPS module (e.g., in communication with one or more servers and/or cell towers and/or satellites) to ascertain a location of user equipment 600. In some embodiments, user equipment 600 comprises a rechargeable battery that is configured to provide power to the components of the device.

Each one of user equipment 600 and user equipment 601 may receive content and data via input/output (I/O) path 602. I/O path 602 may provide content (e.g., broadcast programming, on-demand programming, internet content, content available over a local area network (LAN) or wide area network (WAN), and/or other content) and data to control circuitry 604, which may comprise processing circuitry 606 and storage 608. Control circuitry 604 may be used to send and receive commands, requests, and other suitable data using I/O path 602, which may comprise I/O circuitry. I/O path 602 may connect control circuitry 604 to one or more communications paths (described below). I/O functions may be provided by one or more of these communications paths but are shown as a single path in FIG. 6 to avoid overcomplicating the drawing. While set-top box 615 is shown in FIG. 6 for illustration, any suitable computing device having processing circuitry, control circuitry, and storage may be used in accordance with the present disclosure. For example, set-top box 615 may be replaced by, or complemented by, a personal computer (e.g., a notebook, a laptop, a desktop), a smartphone (e.g., user equipment 600), an XR device, a tablet, a network-based server hosting a user-accessible client device, a non-user-owned device, any other suitable device, or any combination thereof.

Control circuitry 604 may be based on any suitable control circuitry such as processing circuitry 606. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 604 executes instructions for the 3D application stored in memory (e.g., storage 608). Specifically, control circuitry 604 may be instructed by the 3D application to perform the functions discussed above and below. In some implementations, processing or actions performed by control circuitry 604 may be based on instructions received from the 3D application.

In client/server-based embodiments, control circuitry 604 may include communications circuitry suitable for communicating with a server or other networks or servers. The 3D application may be a stand-alone application implemented on a device or a server. The 3D application may be implemented as software or a set of executable instructions. The instructions for performing any of the embodiments discussed herein of the 3D application may be encoded on non-transitory computer-readable media (e.g., a hard drive, random-access memory on a DRAM integrated circuit, read-only memory on a BLU-RAY disk, etc.). For example, in FIG. 6, the instructions may be stored in storage 608, and executed by control circuitry 604 of a user equipment 600.

In some embodiments, the 3D application may be a client/server application where only the client application resides on user equipment 600, and a server application resides on an external server (e.g., server 704 and/or media content source 702). For example, the 3D application may be implemented partially as a client application on control circuitry 604 of user equipment 600 and partially on server 704 as a server application running on control circuitry 711. Server 704 may be a part of a local area network with one or more of user equipment 600, 601 or may be part of a cloud computing environment accessed via the internet. In a cloud computing environment, various types of computing services for performing searches on the internet or informational databases, providing video communication capabilities, providing storage (e.g., for a database) or parsing data are provided by a collection of network-accessible computing and storage resources (e.g., server 704 and/or an edge computing device), referred to as “the cloud.” User equipment 600 may be a cloud client that relies on the cloud computing capabilities from server 704 to generate personalized engagement options in a VR environment.

Control circuitry 604 may include communications circuitry suitable for communicating with a server, edge computing systems and devices, a table or database server, or other networks or servers. The instructions for carrying out the above-mentioned functionality may be stored on a server (which is described in more detail in connection with FIG. 7). Communications circuitry may include a cable modem, an integrated services digital network (ISDN) modem, a digital subscriber line (DSL) modem, a telephone modem, an Ethernet card, or a wireless modem for communications with other equipment, or any other suitable communications circuitry. Such communications may involve the internet or any other suitable communication networks or paths (which is described in more detail in connection with FIG. 7). In addition, communications circuitry may include circuitry that enables peer-to-peer communication of user equipment, or communication of user equipment in locations remote from each other (described in more detail below).

Memory may be an electronic storage device provided as storage 608 that is part of control circuitry 604. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Storage 608 may be used to store various types of content described herein as well as 3D application data described above. Nonvolatile memory may also be used (e.g., to launch a boot-up routine and other instructions). Cloud-based storage, described in relation to FIG. 6, may be used to supplement storage 608 or instead of storage 608. Non-transitory memory may store instructions that, when executed by control circuitry, I/O circuitry, any other suitable circuitry or combination thereof, executes functions of a 3D application as described above.

Control circuitry 604 may include video generating circuitry and tuning circuitry, such as one or more analog tuners, one or more MPEG-2 decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 604 may also include scaler circuitry for upconverting and downconverting content into the preferred output format of user equipment 600. Control circuitry 604 may also include digital-to-analog converter circuitry and analog-to-digital converter circuitry for converting between digital and analog signals. The tuning and encoding circuitry may be used by user equipment 600, 601 to receive and to display, to play, or to record content. The tuning and encoding circuitry may also be used to receive video communication session data. The circuitry described herein, including, for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 608 is provided as a separate device from user equipment 600, the tuning and encoding circuitry (including multiple tuners) may be associated with storage 608.

Control circuitry 604 may receive instruction from a user by way of user input interface 610. User input interface 610 may be any suitable user interface, such as a remote control, mouse, trackball, keypad, keyboard, touch screen, touchpad, stylus input, joystick, voice recognition interface, or other user input interfaces. Display 612 may be provided as a stand-alone device or integrated with other elements of each one of user equipment 600 and user equipment 601. For example, display 612 may be a touchscreen or touch-sensitive display. In such circumstances, user input interface 610 may be integrated with or combined with display 612. In some embodiments, user input interface 610 includes a remote-control device having one or more microphones, buttons, keypads, any other components configured to receive user input or combinations thereof. For example, user input interface 610 may include a handheld remote-control device having an alphanumeric keypad and option buttons. In a further example, user input interface 610 may include a handheld remote-control device having a microphone and control circuitry configured to receive and identify voice commands and transmit information to set-top box 615.

Audio output equipment 614 may be integrated with or combined with display 612. Display 612 may be one or more of a monitor, television, liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 612. Audio output equipment 614 may be provided as integrated with other elements of each one of user equipment 600 and user equipment 601 or may be stand-alone units. An audio component of videos and other content displayed on display 612 may be played through speakers (or headphones) of audio output equipment 614. In some embodiments, audio may be distributed to a receiver (not shown), which processes and outputs the audio via speakers of audio output equipment 614. In some embodiments, for example, control circuitry 604 is configured to provide audio cues to a user, or other audio feedback to a user, using speakers of audio output equipment 614. There may be a separate microphone 616 or audio output equipment 614 may include a microphone configured to receive audio input such as voice commands or speech. For example, a user may speak letters or words that are received by the microphone and converted to text by control circuitry 604. In a further example, a user may voice commands that are received by a microphone and recognized by control circuitry 604. Camera 618 may be any suitable video camera integrated with the equipment or externally connected. Camera 618 may be a digital camera comprising a charge-coupled device (CCD) and/or a complementary metal-oxide semiconductor (CMOS) image sensor. Camera 618 may be an analog camera that converts to digital images via a video card.

The 3D application may be implemented using any suitable architecture. For example, it may be a stand-alone 3D application wholly implemented on each one of user equipment 600 and user equipment 601. In such an approach, instructions of the 3D application may be stored locally (e.g., in storage 608), and data for use by the application is downloaded on a periodic basis (e.g., from an out-of-band feed, from an internet resource, or using another suitable approach). Control circuitry 604 may retrieve instructions of the 3D application from storage 608 and process the instructions to provide video conferencing functionality and generate any of the displays discussed herein. Based on the processed instructions, control circuitry 604 may determine what action to perform when input is received from user input interface 610. For example, movement of a cursor on a display up/down may be indicated by the processed instructions when user input interface 610 indicates that an up/down button was selected. A 3D application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, random access memory (RAM), etc.

Control circuitry 604 may allow a user to provide user profile information or may automatically compile user profile information. For example, control circuitry 604 may access and monitor network data, video data, audio data, processing data, participation data from a conference participant profile. Control circuitry 604 may obtain all or part of other user profiles that are related to a particular user (e.g., via social media networks), and/or obtain information about the user from other sources that control circuitry 604 may access. As a result, a user can be provided with a unified experience across the user's different devices.

In some embodiments, the 3D application is a client/server-based application. Data for use by a thick or thin client implemented on each one of user equipment 600 and user equipment 601 may be retrieved on demand by issuing requests to a server remote to each one of user equipment 600 and user equipment 601. For example, the remote server may store the instructions for the 3D application in a storage device. The remote server may process the stored instructions using circuitry (e.g., control circuitry 604) and generate the displays discussed above and below. The client device may receive the displays generated by the remote server and may display the content of the displays locally on user equipment 600. This way, the processing of the instructions is performed remotely by the server while the resulting displays (e.g., that may include text, a keyboard, or other visuals) are provided locally on user equipment 600. User equipment 600 may receive inputs from the user via user input interface 610 and transmit those inputs to the remote server for processing and generating the corresponding displays. For example, user equipment 600 may transmit a communication to the remote server indicating that an up/down button was selected via user input interface 610. The remote server may process instructions in accordance with that input and generate a display of the 3D application corresponding to the input (e.g., a display that moves a cursor up/down). The generated display is then transmitted to user equipment 600 for presentation to the user.

In some embodiments, the 3D application may be downloaded and interpreted or otherwise run by an interpreter or virtual machine (run by control circuitry 604). In some embodiments, the 3D application may be encoded in the ETV Binary Interchange Format (EBIF), received by control circuitry 604 as part of a suitable feed, and interpreted by a user agent running on control circuitry 604. For example, the 3D application may be an EBIF application. In some embodiments, the 3D application may be defined by a series of JAVA-based files that are received and run by a local virtual machine or other suitable middleware executed by control circuitry 604. In some of such embodiments (e.g., those employing MPEG-2, MPEG-4, HEVC or any other suitable digital media encoding schemes), the 3D application may be, for example, encoded and transmitted in an MPEG-2 object carousel with the MPEG audio and video packets of a program.

As shown in FIG. 7, user equipment 706, 707, 708, 710 (which may correspond to user equipment, e.g., device 106 of FIG. 1, device 200 of FIG. 2, or device 300 of FIG. 3) may be coupled to communication network 709. Communication network 709 may be one or more networks including the internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 709) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 7 to avoid overcomplicating the drawing.

Although communications paths are not drawn between user equipment, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment may also communicate with each other directly through an indirect path via communication network 709.

System 700 may comprise media content source 702, one or more servers 704, and/or one or more edge computing devices. In some embodiments, the 3D application may be executed at one or more of control circuitry 711 of server 704 (and/or control circuitry of user equipment 706, 707, 708, 710 and/or control circuitry of one or more edge computing devices). In some embodiments, the media content source and/or server 704 may be configured to host or otherwise facilitate video communication sessions between user equipment 706, 707, 708, 710 and/or any other suitable user equipment, and/or host or otherwise be in communication (e.g., over communication network 709) with one or more social network services.

In some embodiments, server 704 may include control circuitry 711 and storage 714 (e.g., RAM, ROM, Hard Disk, Removable Disk, etc.). Storage 714 may store one or more databases. Server 704 may also include an I/O path 712. In some embodiments, I/O path 712 is an I/O circuitry. I/O circuitry may be a NIC card, audio output device, mouse, keyboard card, any other suitable I/O circuitry device or combination thereof. I/O path 712 may provide video conferencing data, device information, or other data, over a local area network (LAN) or wide area network (WAN), and/or other content and data to control circuitry 711, which may include processing circuitry, and storage 714. Control circuitry 711 may be used to send and receive commands, requests, and other suitable data using I/O path 712, which may comprise I/O circuitry. I/O path 712 may connect control circuitry 711 to one or more communications paths.

Control circuitry 711 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 711 may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 711 executes instructions for an emulation system application stored in memory (e.g., the storage 714). Memory may be an electronic storage device provided as storage 714 that is part of control circuitry 711. Memory may store instruction to run a 3D application.

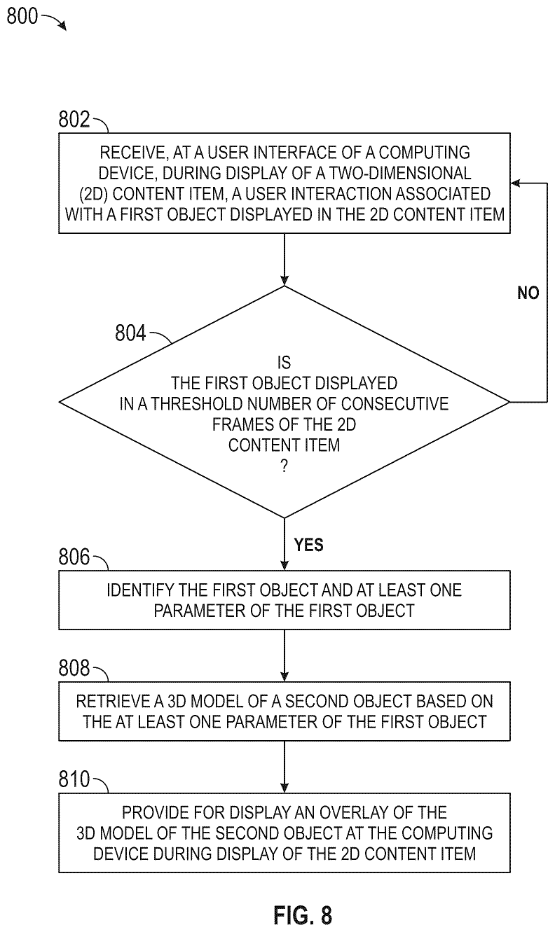

FIG. 8 is a flowchart of an illustrative process for providing for display an overlay of a 3D model of an object at a computing device during display of a 2D content item, in accordance with some embodiments of this disclosure. In various embodiments, the individual steps of process 800 may be implemented by one or more components of the devices and systems of FIGS. 1-3 and FIGS. 6-7 and may be performed in combination with any of the other processes and aspects described herein. Although the present disclosure may describe certain steps of process 800 (and of other processes described herein) as being implemented by certain components of the devices and systems of FIGS. 1-3 and FIGS. 6-7, this is for purposes of illustration only. It should be understood that other suitable components of the devices and systems may implement those steps instead.

In some embodiments, at step 802, control circuitry (e.g., control circuitry 604 of user equipment 600 and/or control circuitry 711 of server 704) receives, at a user interface of a computing device during display of a 2D content item, a user interaction associated with a first object displayed in the 2D content item. The 2D content item may be displayed via I/O circuitry (e.g., I/O circuitry 602 of FIG. 6) at a display screen of the computing device (e.g., device 106 of FIG. 1). For example, control circuitry 604 receives infrared light pulses from a remote control at a portion of the display screen that is currently displaying a first object, e.g., a car, within a movie. At step 804, in some implementations, the control circuitry determines whether the first object is displayed in at least a threshold number of consecutive frames of the 2D content item. For example, control circuitry 604 determines whether the car is displayed in at least, e.g., 100 consecutive frames of the movie displayed at device 106. In some embodiments, the control circuitry determines that the first object is not displayed in at least a threshold number of consecutive frames and waits until another user interaction is received. In some embodiments, the control circuitry determines that the first object is displayed in at least a threshold number of consecutive frames and continues to step 804.

At step 804, in some implementations, the control circuitry identifies the first object and at least one attribute of the first object. For example, as described above in connection with FIG. 1, control circuitry 604 identifies, e.g., using AI image recognition, the first object as a Dodge Challenger. Control circuitry 604 also may identify that the Dodge Challenger is a red sports car (e.g., at least one attribute of the first object). At step 808, in some embodiments, the control circuitry retrieves a 3D model of a second object based on the at least one attribute of the first object. For example, control circuitry 604 retrieves a 3D model, from a 3D model database, of a red Ford Mustang based on the at least one attribute of the Dodge Challenger being a red sports car. At step 810, in some implementations, the control circuitry provides for display an overlay of the 3D model of the second object at the computing device during display of the 2D content item. For example, control circuitry 604 provides for display an overlay of the 3D model of the Ford Mustang at device 106 during display of the movie. The overlay of the 3D model of the second object may be configured to be user interactive. In some embodiments, the control circuitry may receive a second user interaction directed toward the overlay of the 3D model of the second object.

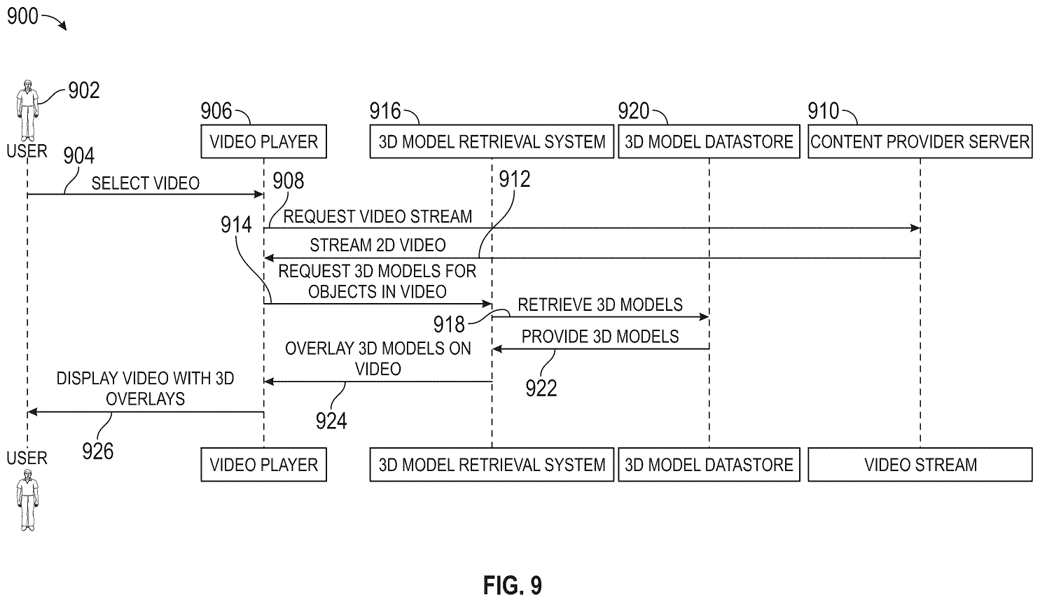

FIG. 9 is a flowchart of an illustrative process for a three-dimensional system for providing for display an overlay of a 3D model of an object at a computing device during display of a 2D content item for client devices with powerful processing capabilities, in accordance with some embodiments of this disclosure. In various embodiments, the individual steps of process 900 may be implemented by one or more components of the devices and systems of FIGS. 1-3 and FIGS. 6-7 and may be performed in combination with any of the other processes and aspects described herein. Although the present disclosure may describe certain steps of process 900 (and of other processes described herein) as being implemented by certain components of the devices and systems of FIGS. 1-3 and FIGS. 6-7, this is for purposes of illustration only. It should be understood that other suitable components of the devices and systems may implement those steps instead.

Process 900 may be performed by a server-client architecture suitable for client devices with powerful processing capabilities. In some embodiments, at step 904, control circuitry (e.g., e.g., control circuitry 604 of user equipment 600 and/or control circuitry 711 of server 704) receives a user selection of a content item (e.g., user 902 selects a video) for display. The content item may be displayed at a computing device, e.g., video player 906. Video player 906 may render and accurately position 3D objects while receiving video on demand (VOD) or live video streaming. At step 908, video player 906, via, e.g., control circuitry 604, requests a video stream from content provider server 910. At step 912, in some embodiments, content provider server 910 sends the requested video stream data to video player 906 and, via the control circuitry, video player 906 provides for display the video stream data as a 2D content item. At step 914, in some implementations, video player 906, via the control circuitry, requests 3D models for objects in the video from 3D model retrieval system 916. The backend API will respond with global motion data of recognized objects and hyperlinks required for advertisement or to provide information for the objects. For example, control circuitry 604 requests 3D models for, e.g., two objects displayed in the 2D content item, e.g., a tire and a tire rim. The tire and the tire rim may be associated with advertising data. At step 918, 3D model retrieval system 916, via the control circuitry, retrieves the requested 3D models from 3D model datastore 920. At step 922, 3D model datastore 920 provides the 3D models to 3D model retrieval system 916.

At step 924, in some embodiments, 3D model retrieval system 916 overlays the 3D models on the video playing at video player 906. At step 926, video player 906 may display the video with the 3D overlays. When a client (e.g., user 902) watches the video and interacts with an object, the control circuitry highlights the object with the 3D model of the object inserted as it appears on the video. The client will then have the option to extract this 3D model, choose another object highlighted in this frame, interact with the 3D model (e.g., pan, rotate, zoom), watch an advertisement video associated with the object, etc.

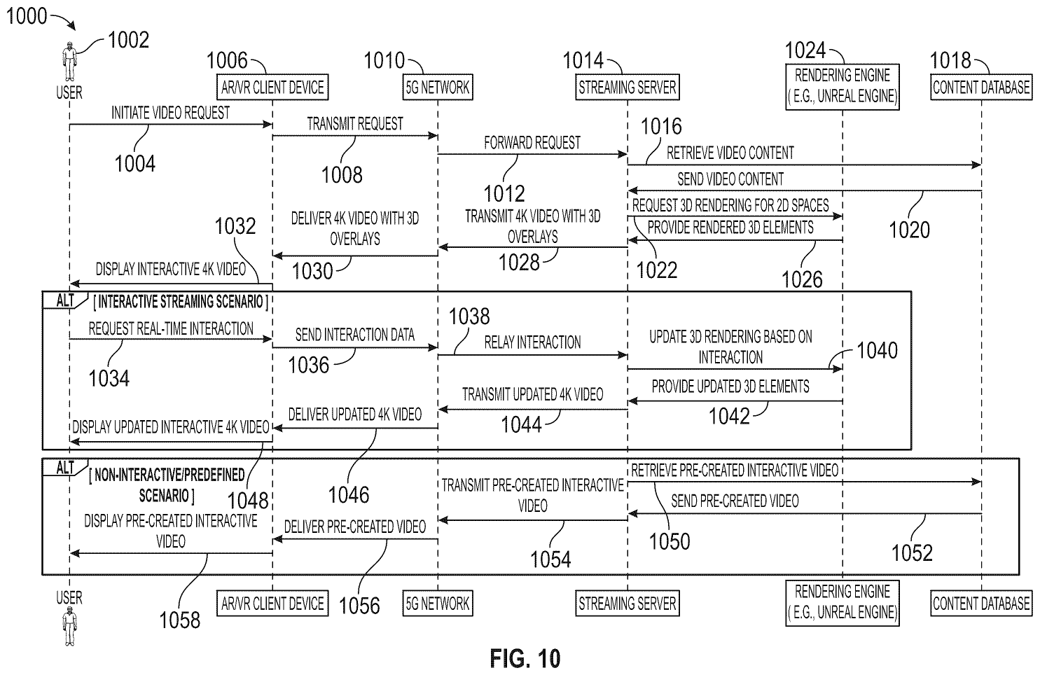

FIG. 10 is a flowchart of an illustrative process for a three-dimensional system, characterized by reliable, ultra-low latency network connections, for providing for display an overlay of a 3D model of an object at a computing device during display of a 2D content item, in accordance with some embodiments of this disclosure. In various embodiments, the individual steps of process 1000 may be implemented by one or more components of the devices and systems of FIGS. 1-3 and FIGS. 6-7 and may be performed in combination with any of the other processes and aspects described herein. Although the present disclosure may describe certain steps of process 1000 (and of other processes described herein) as being implemented by certain components of the devices and systems of FIGS. 1-3 and FIGS. 6-7, this is for purposes of illustration only. It should be understood that other suitable components of the devices and systems may implement those steps instead.

Process 1000 may be performed by a server-client system characterized by reliable, ultra-low latency network connections, particularly suitable for client devices like AR or VR glasses (e.g., AR/VR client device 1006) linked to a server within a 5G provider's infrastructure (e.g., 5G network 1010). With its ultra-low latency and substantial bandwidth, this setup allows the client device to interact seamlessly with the server (e.g., streaming server 1014) and receive high-quality content, such as 4K videos. At step 1004, in some implementations, user 1002 initiates a video request to AR/VR client device 1006 via control circuitry (e.g., control circuitry 604 of user equipment 600 and/or control circuitry 711 of server 704). In some embodiments, at step 1008, AR/VR client device 1006 transmits the video request initiated by user 1002 to 5G network 1010. At step 1012, 5G network 1010 forwards the video request to streaming server 1014. At step 1016, streaming server 1014 retrieves the video content from content database 1018, and content database 1018 sends the video content to streaming server 1014 at step 1020. For example, a streaming service sends movie data to a server near the client device.

In some embodiments, at step 1022, streaming server 1014 requests 3D renderings of objects for 2D spaces from rendering engine 1024 (e.g., Unreal Engine). Streaming server 1014 may primarily handle the 3D rendering and the smooth integration of these elements into 2D spaces. Advanced rendering technologies like Unreal Engine may be utilized alongside interactive streaming protocols such as HEVC with an alpha channel, offloading the computational requirements from AR/VR client device 1006 to streaming server 1014. For example, streaming server 1014 requests a 3D model of an object in the movie, e.g., a car, that may be rendered in the 2D movie from rendering engine 1024. At step 1026, in some implementations, rendering engine 1024 provides rendered 3D elements, e.g., a 3D model of the car, to streaming server 1014. Streaming server 1014 transmits video, e.g., 4K video, with overlay of the 3D model of the car to 5G network 1010 at step 1028. 5G network 1010, in some embodiments, delivers the 4K video with the overlay of the 3D model to AR/VR client device 1006 at step 1030, and AR/VR client device 1006 displays the 4K video with the overlay of the 3D model at step 1032. The overlay of the 3D model of the car may be interactive, e.g., user 1002 may interact with the 3D rendering.

In some embodiments, at step 1034, user 1002 requests real-time interaction with the overlay of the 3D model via the control circuitry of AR/VR client device 1006. For example, control circuitry 604 receives a user interaction via a remote control toward a portion of a display screen of AR/VR client device 1006 that is currently displaying the overlay of the 3D model of the car. At step 1036, in some implementations, AR/VR client device 1006 sends the requested real-time interaction data to 5G network 1010 via the control circuitry. 5G network 1010, at step 1038, may relay the real-time interaction data to streaming server 1014. At step 1040, in some embodiments, streaming server 1014 updates the 3D rendering based on the interaction data. For example, in response to determining that the interaction data indicates that user 1002 zoomed in on the 3D model of the car, streaming server 1014, via control circuitry 604, updates the 3D rendering of the car to be enlarged. At step 1042, in some implementations, rendering engine 1024 provides the updated 3D elements of the 3D model of the car to streaming server 1014 via the control circuitry. In some embodiments, at step 1044, streaming server 1014 transmits updated 4K video, e.g., 4K video with the updated overlay of the zoomed-in 3D model of the car, to 5G network 1010. 5G network 1010 delivers the updated interactive 4K video to AR/VR client device 1006 at step 1046, and AR/VR client device 1006 displays the updated interactive 4K video at step 1048.

This server-centric processing for interactive streaming to a diverse client base demands high computational power, which could restrict the number of clients that can be served simultaneously. An alternative to circumvent this involves creating non-interactive streaming setups or predefined interactive scenarios. For instance, in VOD content, all interactive objects in each scene are predetermined, allowing for the pre-creation of videos with added 3D objects in specified locations. These can then be broadcasted to users, providing an interactive experience focusing on certain things. For example, streaming server 1014, via control circuitry 604, may retrieve pre-created interactive video from content database 1018 at step 1050. In some embodiments, at step 1052, content database 1018 sends the pre-created interactive video to streaming server 1014. At step 1054, streaming server 1014 transmits the pre-created interactive video to 5G network 1010. 5G network 1010, at step 1056, delivers the pre-created interactive video to AR/VR client device 1006, which displays the pre-created interactive video at step 1058. Such a method is particularly advantageous for advertising or display purposes. If there is a need for more user interaction with the 3D models, the provider would need to shift to a fully interactive streaming model. This model allows real-time interaction but comes with increased demands on server processing power to support the interactive elements across various client devices.

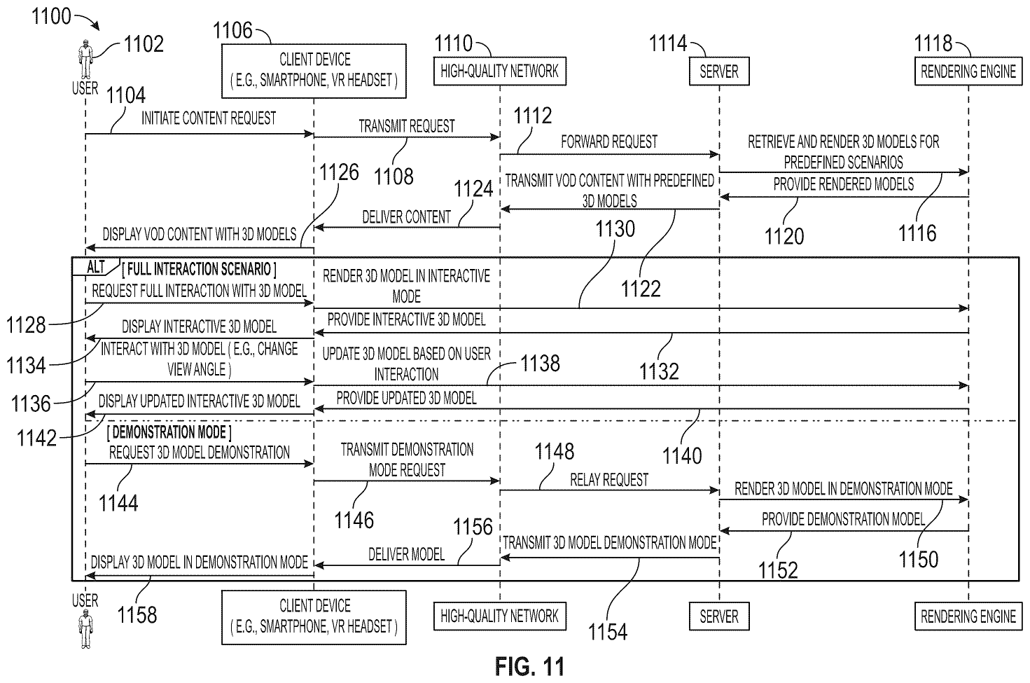

FIG. 11 is a flowchart of an illustrative process for a three-dimensional system for providing for display an overlay of a 3D model of an object at a computing device during display of a 2D content item for client devices that can render 3D models and are simultaneously connected to a high-quality network for interactive streaming from a server, in accordance with some embodiments of this disclosure. In various embodiments, the individual steps of process 1100 may be implemented by one or more components of the devices and systems of FIGS. 1-3 and FIGS. 6-7 and may be performed in combination with any of the other processes and aspects described herein. Although the present disclosure may describe certain steps of process 1100 (and of other processes described herein) as being implemented by certain components of the devices and systems of FIGS. 1-3 and FIGS. 6-7, this is for purposes of illustration only. It should be understood that other suitable components of the devices and systems may implement those steps instead.

Process 1100 may be performed by a server-client system characterized client devices that can render 3D models (i.e., client device 1106) and are simultaneously connected to a high-quality network (e.g., high-quality network 1110) for interactive streaming from a server (e.g., server 1114). Client device 1106 may be a smartphone, VR headset, any other suitable client device, or any combination thereof. Process 1100 may provide content providers flexibility in application deployment, extending adaptability to a broader range of devices. At step 1104, in some implementations, user 1102 initiates a content request to client device 1106 via control circuitry (e.g., control circuitry 604 of user equipment 600 and/or control circuitry 711 of server 704). In some embodiments, at step 1108, client device 1106 transmits the content request initiated by user 1102 to high-quality network 1110 via the control circuitry. At step 1112, high-quality network 1110 forwards the content request to server 1114. In some embodiments, server 1114 stores the content data for the requested content. At step 1116, server 1114 retrieves and renders 3D models for predefined scenarios from rendering engine 1118. In some embodiments, at step 1120, rendering engine 1118 provides server 1114 with rendered 3D models via the control circuitry.

In some embodiments, at step 1122, server 1114 transmits VOD content with predefined 3D models to high-quality network 1110. For example, when the requested content is VOD content and the behavior of objects that 3D models are based on is pre-defined, such as in advertisements or automatic model rendering, server 1114 may perform rendering and placement tasks. In some embodiments, when full interaction with the 3D models is required, rendering may be executed on client device 1106 or via server 1114. At step 1124, high-quality network 1110 may deliver the VOD content with the predefined 3D models to client device 1106 via the control circuitry. In some implementations, at step 1126, client device 1106 displays the VOD content with the 3D models via the control circuitry.

In some embodiments, when full interaction with the 3D models is required, rendering may be executed on client device 1106 or via server 1114. For example, at step 1128, user 1102 requests full interaction with a 3D model from client device 1106. At step 1130, client device 1106 may render the 3D model in interactive mode. In some implementations, server 1114 renders the 3D model in interactive mode. Rendering engine 1118, in some embodiments, provides the interactive 3D model to client device 1106 at step 1132. In some embodiments, rendering engine 1118 provides the interactive 3D model to server 1114. Client device 1106 may, at step 1134, display the interactive 3D model to user 1102. In some embodiments, at step 1136, client device 1106 receives an interaction with the 3D model from user 1102. For example, as described in connection with FIG. 1, user 1102 modifies at least one of an orientation or a size of the overlay of the interactive 3D model. In some implementations, at step 1138, client device 1106 updates the 3D model based on the user interaction. For example, client device 1106 may modify the orientation of the 3D model based on receiving an indication that user 1102 rotated the perspective of the 3D model. In some embodiments, server 1114 updates the 3D model based on the user interaction. At step 1140, rendering engine 1118 may provide the updated 3D model to client device 1106. In some embodiments, rendering engine 1118 provides the updated 3D model to server 1114. At step 1142, client device 1106 displays the updated interactive 3D model. For example, client device 1106, via control circuitry 604, displays the 3D model at a modified viewing angle to user 1102.

In some embodiments, user 1102 requests a 3D model demonstration from client device 1106 at step 1144. At step 1146, client device 1106 may transmit the demonstration mode request to high-quality network 1110. High-quality network 1110, in some implementations, at step 1148, relays the demonstration mode request to server 1114, and server 1114 may render the 3D mode in demonstration mode at step 1150. In some embodiments, rendering engine 1118 provides the demonstration model to server 1114 at step 1152. Server 1114 may then transmit the 3D mode in demonstration mode at step 1154 to high-quality network 1110. High-quality network 1110, in some implementations, at step 1156, delivers the 3D model in demonstration mode to client device 1106. At step 1158, client device 1106 may display the 3D model in a demonstration mode, allowing user 1102 to view the object from various angles. This preliminary exposure will likely reduce the need for client device 1106 to render the 3D model independently. Consequently, user 1102 of client device 1106 is expected to opt less frequently for the interactive mode, necessitating direct interaction with the 3D model. Process 1100 enables the content provider to use the same server capacity across various devices by strategically allocating computational tasks between the server (e.g., server 1114) and client devices (e.g., client device 1106) depending on the interaction level required.

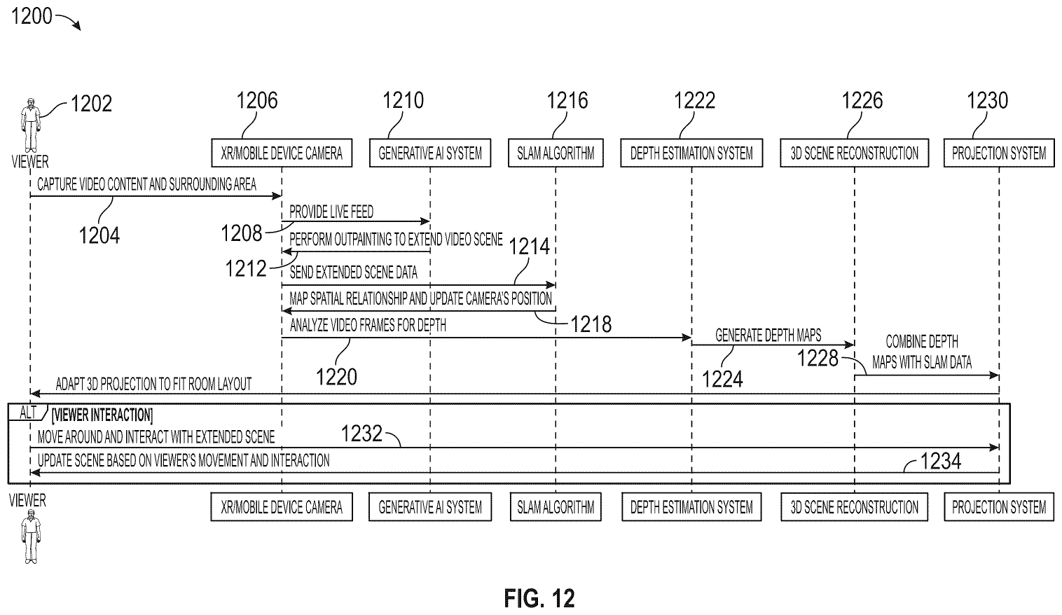

FIG. 12 is a flowchart of an illustrative process for a three-dimensional system for transforming a standard 2D content item into an immersive 3D environment, in accordance with some embodiments of this disclosure. In various embodiments, the individual steps of process 1200 may be implemented by one or more components of the devices and systems of FIGS. 1-3 and FIGS. 6-7 and may be performed in combination with any of the other processes and aspects described herein. Although the present disclosure may describe certain steps of process 1200 (and of other processes described herein) as being implemented by certain components of the devices and systems of FIGS. 1-3 and FIGS. 6-7, this is for purposes of illustration only. It should be understood that other suitable components of the devices and systems may implement those steps instead.

At step 1204, viewer 1202, via control circuitry (e.g., control circuitry 604 of user equipment 600 and/or control circuitry 711 of server 704), captures video content displayed on a user interface of XR/mobile device camera 1206 and the surrounding area of XR/mobile device camera 1206. For example, XR/mobile device camera 1206 displays a user interface that comprises a stream of a movie and the environment detected by the lens of XR/mobile device camera 1206. At step 1208, in some implementations, XR/mobile device camera 1206 provides a live feed of the captured video content and surrounding area to generative AI system 1210. In some embodiments, an input of a reference to a portion within the 2D content item causes generative AI system 1210 to perform step 1212. Generative AI system 1210, at step 1212, may perform outpainting to extend the current video scene to the surrounding area, as described above in connection with FIG. 5. In some embodiments, XR/mobile device camera 1206 sends the extended video scene data, at step 1214, to SLAM algorithm 1216 (described above in connection with FIG. 5). At step 1218, SLAM algorithm 1206, in some implementations, maps the spatial relationship between the physical environment and the video scene and updates the position of XR/mobile camera 1206.

At step 1220, XR/mobile device camera 1206 may analyze the depth of video frames of the 2D content item and provide the analysis to depth estimation system 1222. In some embodiments, depth estimation system 1222 generates depth maps (step 1224) and provides the depth maps to 3D scene reconstruction 1226. 3D scene construction 1226 may convert the 2D outpainting project to a 3D scene. At step 1228, 3D scene reconstruction 1226 may combine the depth maps with SLAM data and send the combination to projection system 1230. Projection system 1230, in some embodiments, adapts the 3D project to fit the room layout of the physical environment captured by XR/mobile device camera 1206. In some embodiments, viewer 1202 may interact with the extended outpainted scene and/or 3D scene. At step 1232, in some implementations, viewer 1202 moves around the extended scene and interacts with the extended scene, as described above in connection with FIG. 5. At step 1234, projection system 1230 may update the extended scene based on the movement and interaction of viewer 1202, as described above in connection with FIG. 1 and FIG. 5.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving, at a user interface of a computing device, during display of a two-dimensional (2D) content item, a user interaction associated with a first object displayed in the 2D content item; and
in response to determining that the first object is displayed in a threshold number of consecutive frames of the 2D content item:
identifying the first object and at least one attribute of the first object;
retrieving a three-dimensional (3D) model of a second object based on the at least one attribute of the first object; and
providing for display an overlay of the 3D model of the second object at the computing device during display of the 2D content item.

2. The method of claim 1, further comprising:
in response to the providing for display the overlay of the 3D model of the second object at the computing device, receiving a second user interaction at the overlay of the 3D model of the second object; and
in response to the receiving the second user interaction, modifying at least one of an orientation or a size of the overlay of the 3D model.

3. The method of claim 2, further comprising:
in response to the receiving the second user interaction, providing for display data of the second object at the user interface of the computing device.

4. The method of claim 3, wherein the data of the second object is advertising data.

5. The method of claim 1, wherein the second object is the first object.

6. The method of claim 1, wherein the second object is different from the first object.

7. The method of claim 1, further comprising:
retrieving a 3D model of a third object based on at least one attribute of the second object;
providing for display an overlay of the 3D model of the third object at the computing device during display of the 2D content item;
generating for display a prompt at the user interface of the computing device;
receiving a second user interaction at the overlay of the 3D model of the second object via the 3D model of the third object, wherein the second user interaction is responsive to the prompt; and
in response to the receiving the second user interaction:
terminating display of the prompt at the user interface of the computing device; and
displaying a portion of the 2D content item at the computing device based on the second user interaction.

8. The method of claim 1, wherein the computing device is an extended reality (XR) device, the method further comprising:
analyzing at least one frame of the consecutive frames of the 2D content item; and
outpainting the at least one frame using generative artificial intelligence (AI).

9. The method of claim 8, further comprising:
analyzing an environment proximate to the XR device;
projecting the outpainted frame at the environment proximate to the XR device; and
receiving a second user interaction at the outpainted frame, wherein at least one object of the outpainted frame is interactive.

10. The method of claim 1, wherein the providing for display the overlay of the 3D model of the second object comprises:
in response to identifying coordinates of the first object in at least one frame of the consecutive frames of the 2D content item, providing for display the overlay of the 3D model at coordinates proximate to the identified coordinates of the first object.

11. A system comprising:
input/output circuitry configured to:
receive, at a user interface of a computing device, during display of a two-dimensional (2D) content item, a user interaction associated with a first object displayed in the 2D content item; and
control circuitry configured to:
in response to determining that the first object is displayed in a threshold number of consecutive frames of the 2D content item:
identify the first object and at least one attribute of the first object;
retrieve a three-dimensional (3D) model of a second object based on the at least one attribute of the first object; and
wherein the input/output circuitry is further configured to:
provide for display an overlay of the 3D model of the second object at the computing device during display of the 2D content item.

12. The system of claim 11, wherein the input/output circuitry is further configured to:
in response to the providing for display the overlay of the 3D model of the second object at the computing device, receive a second user interaction at the overlay of the 3D model of the second object; and
wherein the control circuitry is further configured to:
in response to the receiving the second user interaction, modify at least one of an orientation or a size of the overlay of the 3D model.

13. The system of claim 12, wherein the input/output circuitry is further configured to:
in response to the receiving the second user interaction, provide for display data of the second object at the user interface of the computing device.

14. The system of claim 13, wherein the data of the second object is advertising data.

15. The system of claim 11, wherein the second object is the first object.

16. The system of claim 11, wherein the second object is different from the first object.

17. The system of claim 11, wherein the control circuitry is further configured to:
retrieve a 3D model of a third object based on at least one attribute of the second object;
wherein the input/output circuitry is further configured to:
provide for display an overlay of the 3D model of the third object at the computing device during display of the 2D content item;
generate for display a prompt at the user interface of the computing device;
receive a second user interaction at the overlay of the 3D model of the second object via the 3D model of the third object, wherein the second user interaction is responsive to the prompt; and
in response to the receiving the second user interaction:
terminate display of the prompt at the user interface of the computing device; and
display a portion of the 2D content item at the computing device based on the second user interaction.

18. The system of claim 11, wherein the computing device is an extended reality (XR) device, wherein the control circuitry is further configured to:
analyze at least one frame of the consecutive frames of the 2D content item; and
outpaint the at least one frame using generative artificial intelligence (AI).

19. The system of claim 18, wherein the control circuitry is further configured to:
analyze an environment proximate to the XR device;
wherein the input/output circuitry is further configured to:
project the outpainted frame at the environment proximate to the XR device; and
receive a second user interaction at the outpainted frame, wherein at least one object of the outpainted frame is interactive.

20. The system of claim 11, wherein the input/output circuitry is configured to provide for display the overlay of the 3D model of the second object by:
in response to identifying coordinates of the first object in at least one frame of the consecutive frames of the 2D content item, providing for display the overlay of the 3D model at coordinates proximate to the identified coordinates of the first object.

21-50. (canceled)
